(19) United States
(12) Patent Application Publication
(10) Pub. No.: US 2008/0320536 A1
(43) Pub. Date: Dec. 25, 2008

(54) System and Method for Providing Personalized Datat Broadcasting Service, User Terminal and Method for Using Personalized Data Broadcasting Service, and Data Broadcasting Application Structure Therefor

(76) Inventors: Yong-Ho Kim, Daejeon (KR); Han-Kyu Lee, Daejeon (KR); Min-Sik Park, Daejeon (KR); Jin-Soo Choi, Daejeon (KR); Jin-Woo Hong, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/575,328

(22) PCT Filed: Sep. 16, 2005
(86) PCT No.: PCT/KR2005/003091

§ 371 Date: Mar. 15, 2007

(30) Foreign Application Priority Data
Sep. 16, 2004 (KR) 10-2004-0074236

(51) Int. Cl. H04N 7/173

(52) U.S. Cl. 725/109; 725/134

(57) ABSTRACT

Provided is a system and method for providing a personalized data broadcasting service, a user terminal and method for using a personalized data broadcasting service, and a data broadcasting application structure therefor, to provide a desired broadcasting service to a viewer anytime and anywhere by using diverse terminals. The user terminal includes: a data broadcasting middleware for receiving unidirectional data broadcasting contents transmitted through a broadcasting network; a personalized broadcasting middleware for receiving bidirectional data broadcasting contents transmitted through a communication network; and a contents storing means for storing the unidirectional data broadcasting contents and the bidirectional data broadcasting contents, wherein the data broadcasting middleware executes the unidirectional data broadcasting contents and bidirectional data broadcasting contents. The present invention provides a fast and stable data broadcasting service through a communication-broadcasting integration personalized data broadcasting service. Also, it provides diverse data broadcasting services to each user through a targeting personalized data broadcasting service.

### TECHNICAL FIELD

The present invention relates to a system and method for providing a personalized data broadcasting service, a user terminal and method for using a personalized data broadcasting service, and a data broadcasting application structure therefor, to provide a desired broadcasting service to a viewer anytime and anywhere by using diverse terminals.

### BACKGROUND ART

Personalized broadcasting is standardized to meet broadcasting environment in TV-Anytime (TVA) forum based on contents related to metadata-based contents consumption, which is defined in conventional Moving Picture Experts Group (MPEG)-7, 21. Metadata specifications for the personalized broadcasting are classified into TVA-1 and TVA-2. Basically, the TVA-1 transmits and consumes Audio/Video (AV) contents unidirectionally, and also considers transmitting the AV contents through a communication network. The TVA-2 considers using all contents everywhere with no regard to networks.

However, the TVA specification includes only how to describe in metadata program-related information and a location of contents to download, and how to transmit the metadata. That is, the TVA specification does not suggest a method for producing, transmitting and consuming data broadcasting contents specifically.

In the personalized broadcasting for general AV, contents include one stream or file. On the contrary, in the data broadcasting, since the contents include a plurality of files, a method for producing, transmitting and consuming contents is different from a method used for the general AV. Therefore, the personalized method for the general AV cannot be applied to the personalized broadcasting for data without change.

Meanwhile, in a bidirectional data broadcasting service, control information is transmitted to a viewer as a response, when the data inputted by a viewer is transmitted to a return channel server through the communication network. Therefore, the bidirectional data broadcasting service neither efficiently uses the communication network nor provides a targeting service reflecting user information.

### DISCLOSURE

Technical Problem

It is, therefore, an object of the present invention to provide a method and a system for transmitting data broadcasting contents through a communication network and providing a targeting service based on user information.

It is, also, another object of the present invention to provide a data broadcasting application structure for transmitting the data broadcasting contents through the communication network and providing the targeting service based on the user information.

It is, also, another object of the present invention to provide a method and a user terminal for transmitting data broadcasting contents through the communication network and using the targeting service based on the user information.

Also, the present invention can provide a personalized data broadcasting service as well as a conventional data broadcasting service since a middleware for the personalized broadcasting service is interactively connected without modifying a conventional data broadcasting middleware.

Also, the present invention can provide diverse data broadcasting services in a high quality.

Other objects and advantages of the present invention will be understood by the following description and become more apparent from the embodiments in accordance with the present invention, which are set forth hereinafter. It will be also apparent that objects and advantages of the invention can be embodied easily by the means defined in claims and combinations thereof.

Technical Solution

In accordance with one aspect of the present invention, there is provided a data broadcasting application structure for providing a data broadcasting application structure for providing a personalized data broadcasting service, including: unidirectional data broadcasting contents which include one application start file and are transmitted to provide a data broadcasting service through a broadcasting network; and bidirectional data broadcasting contents transmitted to provide the data broadcasting service through a communication network, wherein the application start file is commonly used in the data broadcasting service through the communication network.

In accordance with another aspect of the present invention, there is provided a system for providing a personalized data broadcasting service, including: an archiver for storing contents; an encoding means for encoding unidirectional contents transmitted through a broadcasting network among the contents; a multiplexing/modulating means for multiplexing, modulating the output signal of the encoding means and transmitting the multiplexed and modulated signal to a user terminal; and a return channel server for acquiring bidirectional contents transmitted through a communication network among the contents upon a request of the user terminal and transmitting the acquired bidirectional contents to the user terminal.

In accordance with another aspect of the present invention, there is provided a user terminal, including: a data broadcasting middleware for receiving unidirectional data broadcasting contents transmitted through a broadcasting network with respect to a data broadcasting program selected by a user; a personalized broadcasting middleware for receiving the bidirectional data broadcasting contents transmitted through a communication network with respect to the data broadcasting program; and a contents storing means for storing the unidirectional data broadcasting contents and bidirectional data broadcasting contents, wherein the data broadcasting middleware executes the unidirectional data broadcasting contents and the bidirectional data broadcasting contents based on signaling information.

In accordance with another aspect of the present invention, there is provided an auxiliary user terminal connected to a main user terminal in home network environment, including: a metadata storing means for storing user information metadata having user information for a targeting service; a personalized broadcasting middleware for acquiring data broadcasting contents suitable for the user information by using contents metadata and the user information metadata transmitted from the main user terminal; and a data broadcasting middleware for executing the acquired data broadcasting contents based on signaling information transmitted from the main user terminal.

In accordance with another aspect of the present invention, there is provided a method for providing a personalized data broadcasting service, including the steps of: a) storing contents; b) encoding unidirectional contents transmitted through a broadcasting network among the contents; c) multiplexing, modulating an output signal of the step b) and transmitting the multiplexed and modulated signal to a user terminal; and d) acquiring bidirectional contents transmitted through a communication network among the contents upon receipt of a request of the user terminal and transmitting the acquired bidirectional contents to the user terminal.

In accordance with another aspect of the present invention, there is provided a method for using a personalized data broadcasting service, including the steps of: a) receiving unidirectional data broadcasting contents transmitted through a broadcasting network with respect to data broadcasting program selected by a user; b) receiving bidirectional data broadcasting contents transmitted through a communication network with respect to the data broadcasting program; c) storing the unidirectional data broadcasting contents and the bidirectional data broadcasting contents in a common storage; and d) executing the unidirectional data broadcasting contents and the bidirectional data broadcasting contents based on signaling information.

In accordance with another aspect of the present invention, there is provided a method for using a personalized data broadcasting service by an auxiliary user terminal connected to a main user terminal in a home network environment, including the steps of: a) storing user information metadata having user information for a targeting service; b) acquiring data broadcasting contents suitable for the user information by using contents metadata and the user information metadata transmitted from the main user terminal; and c) executing the acquired data broadcasting contents based on the signaling information received from the main user terminal.

In accordance with another aspect of the present invention, there is provided a data broadcasting application structure for providing a personalized data broadcasting service, including: one application start file; first resource files which are suitable for first user information; and second resource files which are suitable for second user information, wherein the application start file is commonly used for the first resource files and the second resource files.

In accordance with another aspect of the present invention, there is provided a system for providing a personalized data broadcasting service, including: an archiver storing contents; an encoding means for encoding the contents; and a multiplexer/modulator for multiplexing, modulating the output signal of the encoding means and transmitting the output signal to a user terminal through a broadcasting network, wherein the contents include: a data broadcasting application; and contents metadata for the data broadcasting application, wherein the data broadcasting application includes: first resource files which are suitable for first user information; second resource files which are suitable for second user information; and one application start file commonly used for the first resource files and the second resource files.

In accordance with another aspect of the present invention, there is provided a user terminal, including: a personalized broadcasting middleware for selecting data broadcasting contents suitable for user information by using contents metadata having information on a data broadcasting service and user information metadata having user information; and a data broadcasting middleware for executing the selected data broadcasting contents based on signaling information, wherein the selected data broadcasting contents are received through a broadcasting network.

In accordance with another aspect of the present invention, there is provided a method for providing a personalized data broadcasting service, including the steps of: a) storing contents; b) encoding the contents; and c) multiplexing, modulating an output signal of the step b) and transmitting the multiplexed and modulated signal to a user terminal through a broadcasting network, wherein the contents include: a data broadcasting application; and contents metadata which are metadata with respect to the data broadcasting application, wherein the data broadcasting application includes: the first resource files which are suitable for the first user information; the second resource files which are suitable for the second user information; and one application start file which are commonly used in the first resource files and the second resource files.

In accordance with another aspect of the present invention, there is provided a method for using a personalized data broadcasting service, including the steps of: a) selecting data broadcasting contents suitable for user information by using contents metadata having information on a data broadcasting service and user information metadata having user information; and b) executing the selected data broadcasting contents based on signaling information, wherein the selected data broadcasting contents are transmitted through a broadcasting network.

Advantageous Effects

The present invention provides a fast and stable data broadcasting service through a personalized communication-broadcasting integration data broadcasting service.

Also, the present invention provides diverse types of data broadcasting services for each a user through a targeting personalized data broadcasting service.

Also, the present invention allows a broadcasting provider to satisfy a user's need for a high-grade service and improve profitability through inserting of advertisement by differentiating data broadcasting services through a personalized data broadcasting service of the present invention.

### DESCRIPTION OF DRAWINGS

The above and other objects and features of the present invention will become apparent from the following description of the preferred embodiments given in conjunction with the accompanying drawings, in which:

FIG. 1 is a block diagram showing a data broadcasting application for providing a personalized communication-broadcasting integration data broadcasting service in accordance with an embodiment of the present invention;

FIG. 2 is a block diagram showing a data broadcasting application for providing a personalized communication-broadcasting integration data broadcasting service in accordance with another embodiment of the present invention;

FIG. 3 is a block diagram showing a data broadcasting application for providing a targeting personalized data broadcasting service in accordance with an embodiment of the present invention;

FIG. 4 is a block diagram showing a personalized data broadcasting system for providing and consuming an application in accordance with an embodiment of the present invention; and

FIG. 5 is a block diagram illustrating the metadata database and the personalized broadcasting middleware of FIG. 4.

### BEST MODE FOR THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on prior art may blur the points of the present invention, the detailed description will not be provided herein. The preferred embodiments of the present invention will be described in detail hereinafter with reference to the attached drawings.

One of the characteristic of a personalized data broadcasting service system suggested in the present invention is that a communication network is used in addition to a broadcasting network when data broadcasting contents are downloaded. Herein, two things should be considered. One is that the personalized data broadcasting service system should be compatible with a data broadcasting service only using a conventional broadcasting network. The other is that a data broadcasting middleware should be created to meet the standard specification of data broadcasting.

Accordingly, in the personalized data broadcasting service system of the present invention, a separate personalized broadcasting middleware is in charge of downloading data broadcasting contents through the communication network and a data broadcasting middleware is in charge of downloading data broadcasting contents through the broadcasting network and receiving signaling information.

The contents, which are downloaded through the personalized broadcasting middleware and the data broadcasting middleware, are stored in one storage and the stored contents are executed in the data broadcasting middleware.

A structure and an execution mechanism of the personalized data broadcasting service system of the present invention will be described in detail later, and the above scenario, i.e., a structure of a data broadcasting application for using a communication network with a broadcasting network when downloading data broadcasting contents, will be described herein.

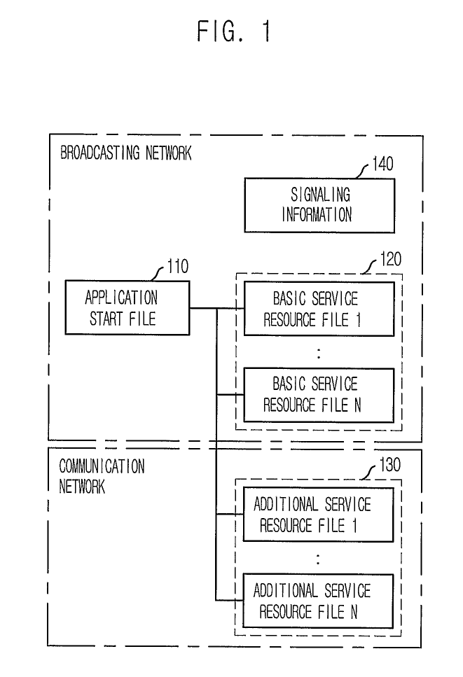

FIG. 1 is a block diagram showing a data broadcasting application for providing a personalized communication-broadcasting integration data broadcasting service in accordance with an embodiment of the present invention.

A signaling information 140 is an execution information of a data broadcasting application and includes Application Information Table (AIT) of Advanced Common Application Platform (ACAP) or Multimedia Home Platform (MHP). The signaling information 140 includes detailed information for an application such as environment and a start file required for executing the application as well as general information such as a title and contents of a data broadcasting application.

An application start file 110 is an application file, into which a code for starting an application is inserted. In a java application, a class file having a main method corresponds to the start file. In a web application, a first executed file such as index.htm corresponds to the application start file.

When data broadcasting is provided in education broadcasting, data broadcasting for basic learning is provided to all viewers for free and data broadcasting for in-depth learning can be provided to only additionally paying users. Herein, the former is a basic service and the latter is an additional service. There are diverse resource files such as image, text and audio for data broadcasting. The resource file used in the basic service is a basic service resource file 120 and the resource file used in the additional service is an additional service resource file 130.

The signaling information 140 cannot be described in TVA metadata and should be transmitted through the broadcasting network all the time for comparability with the conventional data broadcasting. However, the data broadcasting contents do not always have to be transmitted to the broadcasting network. Therefore, as shown in FIG. 1, it is possible to form an application that a user can additionally select and use by transmitting the application start file 110 and the resource file 120 for the basic service through the broadcasting network and the resource files 130 through the communication network.

Herein, since the application start file 110 is not individually used, but only one 110 is commonly used for a basic service and an additional service, the application having the structure of the present invention can be used in the current data broadcasting specifications.

Meanwhile, the signaling information 140 is transmitted through the broadcasting network for compatibility with the conventional data broadcasting, and it is also possible to transmit all of the application start file 110 and the resource files 120 and 130 through the communication network. However, an error can be generated and a service cannot be used in a terminal to which a communication network is not connected, if all contents are transmitted through the communication network. Therefore, it is preferable to transmit only the additional service resource file through the communication network, as shown in FIG. 1.

Also, it is possible to transmit all contents through both broadcasting network and communication network in duplication to provide much faster data broadcasting service. In this case, a terminal not connected to a communication network can use all data broadcasting services although it takes some time, and a terminal connected to the communication network can use the fast data broadcasting service.

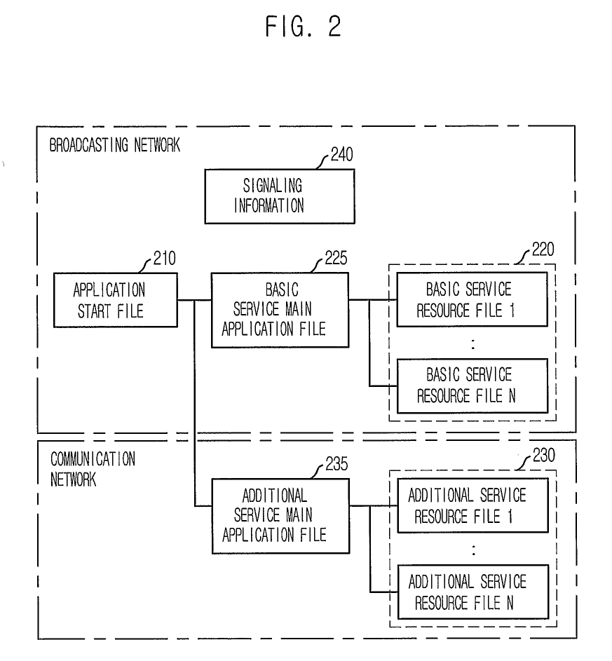

Meanwhile, FIG. 2 is a block diagram showing a data broadcasting application for providing a personalized communication-broadcasting integration data broadcasting service in accordance with another embodiment of the present invention.

An application start file 210, resource files 220 for a basic service, resource files 230 for an additional service and a signaling information 240 correspond to the application start file 110, the resource files 120 for the basic service, resource files 130 for the additional service and the signaling information 140 of FIG. 1, respectively. The application structure further includes a basic service main application file 225 and an additional service main application file 235. The basic service main application file 225 and the additional service main application file 235 represent a java file, an Extensible Markup Language (XML) file and a Hypertext Markup Language (HTML) file, which are executable and described with respect to time, spatial location and an execution method of resource files to provide the basic service and the additional service, respectively.

Meanwhile, another characteristic of the personalized data broadcasting service system of the present invention is that the personalized data broadcasting service system can provide a targeting service. As an example, when there are users watching data broadcasting by using a high definition (HD) digital TV and user watching data broadcasting by using a personal digital assistance (PDA) of low definition or a monitor of low specification, transmitting only data which are suitable only for one resolution to users generates a problem that data are damaged or an angled image is printed, due to scaling. Also, when there are users who want contents having a Korean text and users who want contents having an English text, it is necessary to provide desirable data to each user.

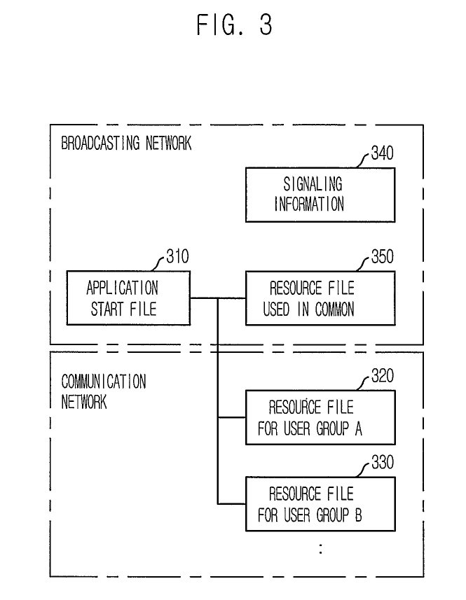

FIG. 3 is a block diagram showing a data broadcasting application for providing a targeting personalized data broadcasting service in accordance with an embodiment of the present invention. As shown in FIG. 3, a resource file 350 commonly used in one application start file should be always transmitted, and resource files 320 for user group A and resource files 320 for user group B should be transmitted only to a terminal corresponding to the user group A and terminals corresponding to the user group B respectively. Herein, the application structure can further include a main application file for the user group A and a main application file for the user group B.

All of an application start file 310, a signaling information 340, and the resource files 320, 330, and 350 can be transmitted through a broadcasting network.

Meanwhile, the targeting personalized data broadcasting service can be connected to the personalized communication-broadcasting integration data broadcasting service. As shown in FIG. 3, the signaling information 340 and common contents for each user group, that is, the application start file 310 and the commonly used resource file 350 are transmitted through a broadcasting network, and the resource files 320 and 330 for each user group are transmitted through a communication network.

However, the resource files of at least one group among the resource files 320 and 330 for user groups should be transmitted through the broadcasting network in order to use a data broadcasting service in a user terminal supporting data broadcasting only through a broadcasting network. In particular, the resource files 320 and 330 for user groups should be transmitted through the broadcasting network in order to provide a targeting service to a user terminal supporting data broadcasting only through the broadcasting network. However, when all terminals support the personalized communication-broadcasting integration, data broadcasting service, the application structure of FIG. 3 is preferred.

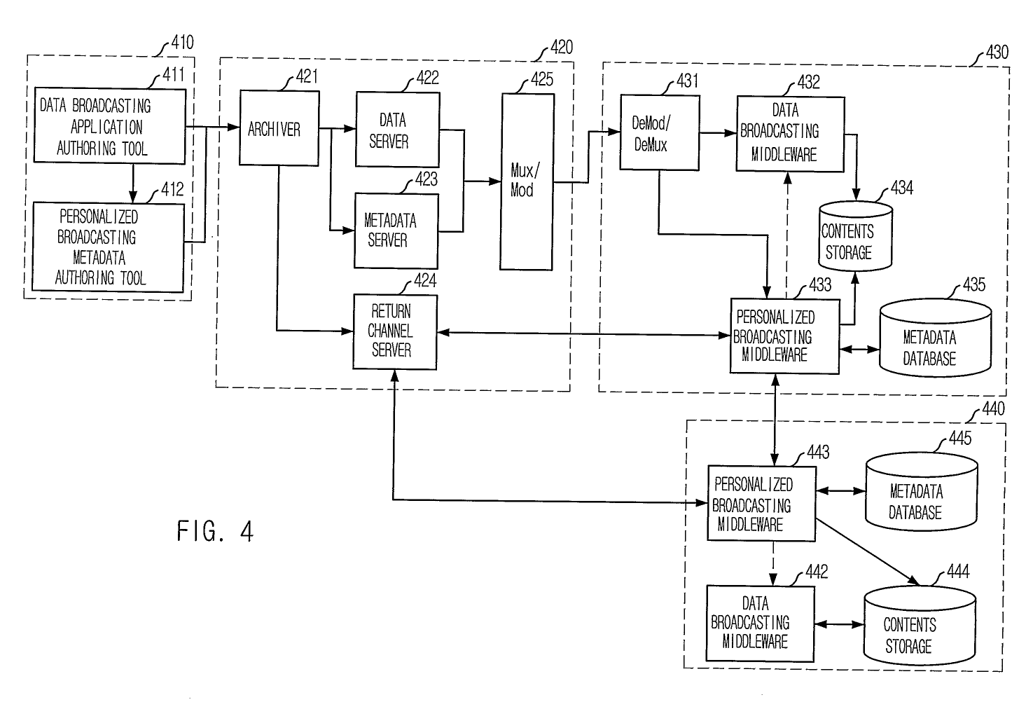

FIG. 4 is a block diagram showing a personalized data broadcasting system for providing and consuming an application in accordance with an embodiment of the present invention.

A contents provider 410 is a contents creator for a personalized data broadcasting service. The contents include data broadcasting contents, i.e., a data broadcasting application and diverse files included in the data broadcasting application, and metadata for the personalized broadcasting. The application creator generates a data broadcasting application of the structure of the present invention by using a data broadcasting application authoring tool 411. When the data broadcasting program is related to an AV program, the data broadcasting application is created by referring to AV contents. When the data broadcasting program is not related to the AV program, the data broadcasting application is independently created. The created application is stored in a personalized data broadcasting service providing system 420 such as an archiver 421, which is a storage of a broadcasting station.

The data broadcasting application itself or the data broadcasting application-related information is provided to a metadata creator. In case of a data broadcasting program related to the AV program, AV program information is also provided to the metadata creator. The metadata creator creates contents metadata, which are metadata for the personalized broadcasting, by using the personalized broadcasting metadata authoring tool 412 to be suitable for TV Anytime (TVA) schema. The created contents metadata are also stored in the archiver 421 of the personalized data broadcasting service providing system 420. The contents metadata include metadata having information related to a schedule of a data broadcasting service, metadata having information related to contents and description of a data broadcasting service and metadata having location information of data broadcasting application contents.

Among contents stored in the archiver 421, Unidirectional data broadcasting contents and unidirectional metadata contents are individually encoded in each of a data server 422 and the metadata server 423, generated as Moving Picture Expert Group 2—Transport Stream (MPEG2-TS) according to a schedule information, and transmitted to a user terminal 430 through a broadcasting network going through the multiplexer/modulator 425.

Among contents stored in the archiver 421, the bidirectional data broadcasting contents and the bidirectional metadata contents are transmitted to a user terminal 430 through a communication network going through a return channel server 424.

Herein, the unidirectional contents are transmitted through a broadcasting network and the bidirectional contents are transmitted through a communication network. In FIG. 1, the application start file 110 and the resource files 120 for a basic service are included in the unidirectional data broadcasting contents and the resource files 130 are included in the bidirectional data broadcasting contents for an additional service. Also, in FIG. 3, the application start file 310 and the commonly used resource files 350 are included in the unidirectional data broadcasting contents, and the resource files 320 for the user group A and the resource files 330 for the user group B are included in the bidirectional data broadcasting contents.

The contents metadata are transmitted to the user terminal 430 through a broadcasting network or a communication network before a data broadcasting program starts. When the contents metadata are transmitted to the broadcasting network, the contents metadata are transmitted to a personalized broadcasting middleware 433 through a demodulator/demultiplexer 431 of the user terminal 430. When the contents metadata are transmitted through a communication network, the contents metadata are transmitted to the personalized broadcasting middleware 433 through the return channel server 424. The transmitted contents metadata are stored in a metadata database 435.

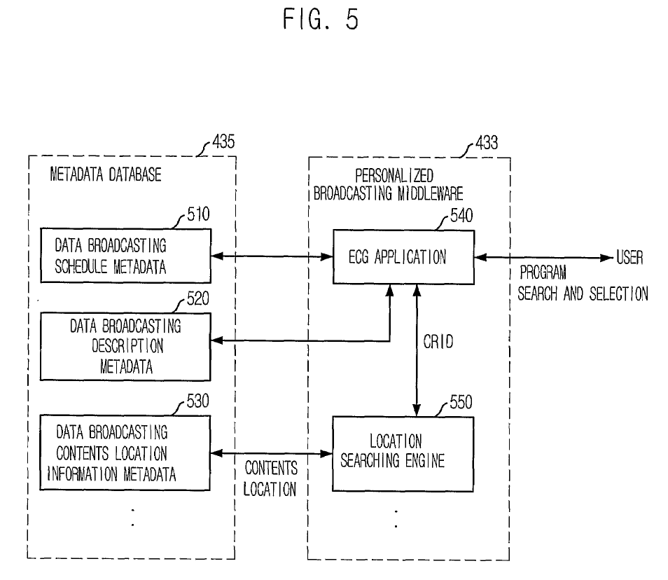

As shown in FIG. 5, the personalized broadcasting middleware 433 acquires schedule information and detailed information from a data broadcasting schedule metadata 510 and the data broadcasting description metadata 520, and provides the schedule information and the detailed information to a user through an Electronic Contents Guide (ECG) application 540. FIG. 5 is a block diagram illustrating the metadata database and the personalized broadcasting middleware of FIG. 4. The ECG application 540 can be formed separately from the personalized broadcasting middleware 433. The user can search and select a data broadcasting program to watch through the ECG application 540.

When the user selects the data broadcasting program through the ECG application 540, the information is transmitted to the demodulator/demultiplexer 431 and a location searching engine 550 of the personalized broadcasting middleware 433. The demodulator/demultiplexer 431 is in charge of tuning a channel in time corresponding to schedule information and transmitting TS including contents corresponding to the selected data broadcasting program to a data broadcasting middleware 432, and the data broadcasting middleware 432 is in charge of analyzing the transmitted TS, binding contents and storing the contents into a contents storage 434. When the selected data broadcasting program is available to watch now, it is possible to watch and record the data broadcasting program, and when the selected data broadcasting program is expected to be broadcasted, it is possible to prerecord the data broadcasting program. When recording or prerecording the data broadcasting program, the data broadcasting contents transmitted through a broadcasting network are stored as the TS in the contents storage 434. When restoring the data broadcasting contents, the data broadcasting middleware 432 decodes data of a carousel and executes the decoded data by signaling information.

The location searching engine 550 of the personalized broadcasting middleware 433 searches location information of contents required for the data broadcasting program selected by a user, based on a TVA procedure. That is, a location searching engine 550 searches a locator of contents based on a TVA location resolution mechanism from the data broadcasting contents location metadata 530 by using Content Reference Identifier (CRID) of the data broadcasting program selected by a user. When there are data broadcasting contents to receive through a communication network in the search result, the personalized broadcasting middleware 433 downloads bidirectional data broadcasting contents through the return channel server 424 and stores the bidirectional data broadcasting contents in the contents storage 434.

Herein, it should be considered that an application starts by signaling information transmitted through the broadcasting network, as soon as unidirectional data broadcasting contents through the broadcasting network is downloaded completely. Therefore, the bidirectional data broadcasting contents through communication network should be downloaded completely before the unidirectional data broadcasting contents are downloaded. It is preferable to download the bidirectional data broadcasting contents in advance before program starts except a case that the data broadcasting program is instantly watched. When the data broadcasting program is instantly watched, it is necessary to additionally control the personalized broadcasting middleware 433 with respect to the data broadcasting middleware 432. The application can be executed after the download of the bidirectional data broadcasting contents by controlling an application life cycle of the data broadcasting middleware 432 by a contents download managing module of the personalized broadcasting middleware 433.

The data broadcasting middleware 432 executes the bidirectional data broadcasting contents and the unidirectional data broadcasting contents, which are stored in the contents storage 434, through signaling information and provides the bidirectional data broadcasting contents and the unidirectional data broadcasting contents to a display of a user terminal.

Meanwhile, when the targeting personalized data broadcasting service is provided, the user information metadata including a user profile, preference and terminal characteristic information should be pre-stored in the metadata data base 435 of the user terminal 430. The personalized broadcasting middleware 433 compares the user information from the user information metadata to the data broadcasting description information from the data broadcasting description metadata 520. The personalized broadcasting middleware 433 selects data broadcasting contents, which are suitable for the user information, and searches location information based on a TVA procedure.

In a search result, when the data broadcasting contents, which are suitable for the user information, should be obtained through a communication network, the personalized broadcasting middleware 433 downloads the data broadcasting contents through the return channel server 424 and stores the data broadcasting contents in the contents storage 434. The data broadcasting middleware 432 executes the stores data broadcasting contents through the signaling information and provides the data broadcasting contents to the display of the user terminal.

When the data broadcasting contents, which are suitable for the user information, are stored in the contents storage 434 through a broadcasting network, the data broadcasting middleware 432 executes the stored data broadcasting contents through the signaling information and provides the data broadcasting contents to the display of the user terminal.

Meanwhile, a second user terminal 440 can be connected to a first user terminal 430 through a home network. When the first user terminal 430 functions as Personal Digital Recorder (PDR), the second user terminal 430 can directly receive the data broadcasting contents and the contents metadata of the first user terminal 430 from the first user terminal 430. When the first user terminal 430 functions as the PDR, the first user terminal 430 is in charge of storing contents. Therefore, the first user terminal 430 has a function of assigning contents to other user terminals at home.

More specifically, the second user terminal 440 includes a data broadcasting middleware 442, a personalized broadcasting middleware 443, a contents storage 444 and a metadata database 445. The personalized broadcasting middleware 443 compares the data broadcasting description information of the data broadcasting description metadata transmitted from the first user terminal to the user information of the user information metadata stored in the database 445, and selects the data broadcasting contents, which are suitable for the second user terminal 440. The data broadcasting contents are extracted from the contents storage 434 of the first user terminal 430 and stored in the contents storage 444 through the personalized broadcasting middleware 433 and 443.

When the corresponding data broadcasting contents do not exist in the contents storage 434 of the first user terminal 430, the personalized broadcasting middleware 443 can directly download the data broadcasting contents through the return channel server 424. In another method, the personalized broadcasting middleware 433 of the first user terminal 430 downloads the data broadcasting contents through the return channel server 424 and provides the data broadcasting contents to the personalized broadcasting middleware 443 of the second user terminal 440.

The second user terminal 440 does not have a broadcasting network download module, which corresponds to the demodulator/demultiplexer 431 of the first user terminal 430. Therefore, the first user terminal 430 transmits signaling information having information related to an application start file and execution environment as a metadata type such as Programming Metadata Communication Protocol (PMCP) instead of a TVA metadata type. The data broadcasting middleware 442 executes the data broadcasting contents, which are stored in the contents storage 444, through the signaling information and provides the data broadcasting contents to the display of the user terminal.

Meanwhile, the personalized data broadcasting system suggested in FIG. 4 can be applied to a targeting service only through a broadcasting network.

The data broadcasting application created by the contents provider 410 and the data broadcasting application-related contents metadata are stored in the personalized data broadcasting service providing system 420 such as the archiver 421, which is a storage of a broadcasting station. The contents metadata includes metadata having information related to a schedule of a data broadcasting service, metadata having information related to contents and description of a data broadcasting service and metadata having location information of data broadcasting application contents.

The unidirectional data broadcasting contents stored in the archiver 421 and the contents metadata are, respectively, encoded in the data server 422 and the metadata server 423 based on schedule information, generated as the MPEG2-TS and transmitted to the user terminal 430 through the broadcasting network going through the multiplexer/modulator 425. Herein, the unidirectional data broadcasting contents means a data broadcasting application transmitted through a broadcasting network.

The contents metadata are transmitted to the user terminal 430 through the broadcasting network before the data broadcasting program starts. The contents metadata are transmitted to the personalized broadcasting middleware 433 through the demodulator/demultiplexer 431 of the user terminal 430. The transmitted contents metadata are stored in the metadata database 435.

As shown in FIG. 5, the personalized broadcasting middleware 433 acquires schedule information and detailed information from the data broadcasting schedule metadata 510 and the data broadcasting description metadata 520, and provides the schedule information and the detailed information to a user through the ECG application 540. The user can search and select a data broadcasting program to watch through the ECG application 540.

When the user selects a data broadcasting program through the ECG application 540, the corresponding information is transmitted to the demodulator/demultiplexer 431 and the location searching engine 550 of the personalized broadcasting middleware 433.

There are two methods for providing a targeting service.

In one method, the demodulator/demultiplexer 431 is in charge of tuning a channel in time corresponding to the schedule information and transmitting the contents corresponding to the selected data broadcasting program to the data broadcasting middleware 432, and the data broadcasting middleware 432 is in charge of storing the transmitted contents, which are all contents diversely classified based on user information, in the contents storage 434.

The personalized broadcasting middleware 433 compares the user information from the user information metadata with the data broadcasting description information from the data broadcasting description metadata 520. The user information metadata includes a user profile, preference information and terminal characteristic information, and are pre-stored in the metadata data base 435 of the user terminal 430.

The personalized broadcasting middleware 433 selects data broadcasting contents, which are suitable for user information, and searches location information based on a TVA procedure. That is, the location searching engine 550 searches a locator of the data broadcasting contents, which are suitable for user information, by TVA location resolution mechanism from the data broadcasting contents location metadata 530 by using the Content Reference Identifier (CRID) of the selected data broadcasting program.

The personalized broadcasting middleware 433 shifts the data broadcasting contents having the searched location information to an execution location of the contents storage 434, which makes it possible that the data broadcasting contents are executed by the data broadcasting middleware 432. The data broadcasting middleware 432 executes the data broadcasting contents, which are suitable for user information, through signaling information, and provides the data broadcasting contents to the display of the user terminal.

In the second method, the demodulator/demultiplexer 431 tunes a channel in time according to the schedule information, and transmits the contents corresponding to the selected data broadcasting program to the data broadcasting middleware 432.

The personalized broadcasting middleware 433 compares the user information from the user information metadata to the data broadcasting description information from the data broadcasting description metadata 520. The personalized broadcasting middleware 433 selects the data broadcasting contents, which are suitable for the user information, and searches location information based on a TVA procedure.

The personalized broadcasting middleware 433 provides the searched location information to the data broadcasting middleware 432. The data broadcasting middleware 432 stores only the data broadcasting contents having the provided location information in an execution location of the contents storage 434 from the demodulator/demultiplexer 431, and makes it possible for the data broadcasting contents to be executed. The data broadcasting middleware 432 executes the data broadcasting contents, which are suitable for user information, through signaling information, and provides the data broadcasting contents to the display of the user terminal.

Meanwhile, the second user terminal 440 can be connected to a first user terminal 430 through a home network. When the first user terminal 430 functions as a PDR, the second user terminal 430 can directly receive the data broadcasting contents and the contents metadata of the first user terminal 430 from the first user terminal 430.

More specifically, the second user terminal 440 includes the data broadcasting middleware 442, the personalized broadcasting middleware 443, the contents storage 444 and the metadata database 445. The personalized broadcasting middleware 443 compares the data broadcasting description information of the data broadcasting description metadata, which are transmitted from the first user terminal, to the user information of the user information metadata, which are stored in the database 445, and selects data broadcasting contents, which are suitable for the second user terminal 440. The data broadcasting contents are extracted from the contents storage 434 of the first user terminal 430 and stored in the contents storage 444 going through the personalized broadcasting middleware 433 and 443.

The second user terminal 440 does not have a broadcasting network download module, which corresponds to the demodulator/demultiplexer 431 of the first user terminal 430. Therefore, the first user terminal 430 transmits signaling information having information on an application start file and execution environment as a metadata type such as PMCP instead of a TVA metadata type. The data broadcasting middleware 442 executes the data broadcasting contents, which are stored in the contents storage 444, through the signaling information and provides the data broadcasting contents to the display of the user terminal.

While the present invention has been described with respect to certain preferred embodiments, it will be apparent to those skilled in the art that various changes and modifications may be made without departing from the scope of the invention as defined in the following claims.

### INDUSTRIAL APPLICABILITY

The present invention can be used in a data broadcasting system.

What is claimed is:

1. A data broadcasting application structure for providing a personalized data broadcasting service, comprising:
unidirectional data broadcasting contents which include one application start file and are transmitted to provide a data broadcasting service through a broadcasting network; and
bidirectional data broadcasting contents transmitted to provide the data broadcasting service through a communication network,
wherein the application start file is commonly used in the data broadcasting service through the communication network.

2. The structure as recited in claim 1, wherein the unidirectional data broadcasting contents include resource files for providing a basic data broadcasting service, and the bidirectional data broadcasting contents include resource files for providing an additional data broadcasting service.

3. The structure as recited in claim 1, wherein the unidirectional data broadcasting contents include resource files commonly used in user terminals, and the bidirectional data broadcasting contents include resource files classified based on user information.

4. The structure as recited in claim 1, wherein the unidirectional data broadcasting contents include resource files for providing a targeting service to a first user group, and the bidirectional data broadcasting contents include resource files for providing the targeting service to a second user group.

5. A system for providing a personalized data broadcasting service, comprising:
an archiver for storing contents;
an encoding means for encoding unidirectional contents transmitted through a broadcasting network among the contents;
a multiplexing/modulating means for multiplexing, modulating the output signal of the encoding means and transmitting the multiplexed and modulated signal to a user terminal; and
a return channel server for acquiring bidirectional contents transmitted through a communication network among the contents upon a request of the user terminal and transmitting the acquired bidirectional contents to the user terminal.

6. The system as recited in claim 5, wherein the contents include:
a data broadcasting application; and
contents metadata which are metadata for the data broadcasting application.

7. The system as recited in claim 6, wherein the data broadcasting application includes:
unidirectional data broadcasting contents which include one application start file and transmitted to provide a data broadcasting service through a broadcasting network; and
bidirectional data broadcasting contents which are transmitted for providing a data broadcasting service through a communication network,
wherein the application start file is commonly used in a data broadcasting service through the communication network.

8. The system as recited in claim 6, wherein the contents metadata are transmitted to the user terminal through the broadcasting network or the communication network.

9. The system as recited in claim 6, wherein the contents metadata include:
metadata having information related to a schedule of the data broadcasting service;
metadata having information related to content and detailed description of the data broadcasting service; and
metadata having a location information of the data broadcasting application.

10. The system as recited in claim 7, wherein the encoding means includes:
a data server for forming the unidirectional data broadcasting contents into Moving Picture Expert Group 2-Transport Stream (MPEG2-TS); and
a metadata server for forming the contents metadata into MPEG2-TS.

11. A user terminal, comprising:
a data broadcasting middleware for receiving unidirectional data broadcasting contents transmitted through a broadcasting network with respect to a data broadcasting program selected by a user;
a personalized broadcasting middleware for receiving bidirectional data broadcasting contents transmitted through a communication network with respect to the data broadcasting program; and
a contents storing means for storing the unidirectional data broadcasting contents and the bidirectional data broadcasting contents,
wherein the data broadcasting middleware executes the unidirectional data broadcasting contents and the bidirectional data broadcasting contents based on signaling information.

12. The user terminal as recited in claim 11, further comprising:
a metadata storing means for storing contents metadata having information on a data broadcasting service, and the contents metadata are received through the broadcasting network or the communication network.

13. The user terminal as recited in claim 12, wherein the personalized broadcasting middleware extracts schedule information and detailed information of the data broadcasting service from the contents metadata, and provides the schedule information and the detailed information to the user.

14. The user terminal as recited in claim 11, wherein the personalized broadcasting middleware searches location information of contents required for the selected data broadcasting program based on a TVA location resolution mechanism.

15. The user terminal as recited in claim 14, wherein when the contents required for the data broadcasting program are the bidirectional data broadcasting contents as a result of searching the location information, the personalized broadcasting middleware downloads the contents through a return channel server.

16. The user terminal as recited in claim 11, wherein the personalized broadcasting middleware controls an application cycle of the data broadcasting middleware to execute the application after the bidirectional data broadcasting contents are downloaded.

17. The user terminal as recited in claim 12, wherein the metadata storing means further includes user information metadata having user information for a targeting service.

18. The user terminal as recited in claim 17, wherein the personalized broadcasting middleware selects data broadcasting contents of a type suitable for the user information by using the contents metadata and the user information metadata.

19. The user terminal as recited in claim 18, wherein the personalized broadcasting middleware downloads data broadcasting contents through the return channel server when the selected data broadcasting contents are the bidirectional data broadcasting contents.

20. An auxiliary user terminal connected to a main user terminal in home network environment, comprising:
a metadata storing means for storing user information metadata having user information for a targeting service;
a personalized broadcasting middleware for acquiring data broadcasting contents suitable for the user information by using contents metadata and the user information metadata transmitted from the main user terminal; and
a data broadcasting middleware for executing the acquired data broadcasting contents based on signaling information transmitted from the main user terminal.

21. The terminal as recited in claim 20, wherein the personalized broadcasting middleware acquires the data broadcasting contents from the main user terminal.

22. The terminal as recited in claim 20, wherein the personalized broadcasting middleware directly downloads the data broadcasting contents through a return channel server.

23. A method for providing a personalized data broadcasting service, comprising the steps of:
a) storing contents;
b) encoding unidirectional contents transmitted through a broadcasting network among the contents;
c) multiplexing, modulating an output signal of the step b) and transmitting the multiplexed and modulated signal to a user terminal; and
d) acquiring bidirectional contents transmitted through a communication network among the contents upon receipt of a request of the user terminal and transmitting the acquired bidirectional contents to the user terminal.

24. The method as recited in claim 23, wherein the contents include:
a data broadcasting application; and
contents metadata which are metadata for the data broadcasting application.

25. The method as recited in claim 24, wherein the data broadcasting application includes:
unidirectional data broadcasting contents which include one application start file and are transmitted to provide a data broadcasting service through a broadcasting network; and
bidirectional data broadcasting contents transmitted to provide a data broadcasting service through a communication network,
wherein the application start file is commonly used in the data broadcasting service through the communication network.

26. The method as recited in claim 24, wherein the metadata are transmitted to the user terminal through the broadcasting network or the communication network.

27. The method as recited in claim 24, wherein the contents metadata include:
metadata having information on a schedule of a data broadcasting service;
metadata having information on content and detailed description of the data broadcasting service; and
metadata having location information of the data broadcasting application.

28. The method as recited in claim 25, wherein the step b) includes the steps of:
b1) forming the unidirectional data broadcasting contents into Moving Picture Expert Group 2-Transport Stream (MPEG2-TS); and
b2) forming the contents metadata into MPEG2-TS.

29. A method for using a personalized data broadcasting service, comprising the steps of:
a) receiving unidirectional data broadcasting contents transmitted through a broadcasting network with respect to data broadcasting program selected by a user;
b) receiving bidirectional data broadcasting contents transmitted through a communication network with respect to the data broadcasting program;
c) storing the unidirectional data broadcasting contents and the bidirectional data broadcasting contents in a common storage; and
d) executing the unidirectional data broadcasting contents and the bidirectional data broadcasting contents based on signaling information.

30. The method as recited in claim 29, further including:
e) receiving contents metadata having information on a data broadcasting service through the broadcasting network or the communication network

31. The method as recited in claim 29, further including:
f) searching location information of contents required for the selected data broadcasting program based on a TVA location resolution mechanism.

32. The method as recited in claim 31, further including:
g) downloading the contents required for the selected data broadcasting program through a return channel server when the contents required for the data broadcasting program are bidirectional data broadcasting contents as a result of searching the location information.

33. The method as recited in claim 30, further including:
h) acquiring data broadcasting contents of a certain type which is suitable for user information by using the contents metadata and user information metadata having the user information.

34. A method for using a personalized data broadcasting service by an auxiliary user terminal connected to a main user terminal in a home network environment, comprising the steps of:
a) storing user information metadata having user information for a targeting service;
b) acquiring data broadcasting contents suitable for the user information by using contents metadata and the user information metadata transmitted from the main user terminal; and
c) executing the acquired data broadcasting contents based on the signaling information received from the main user terminal.

35. The method as recited in claim 34, wherein the data broadcasting contents are acquired from the main user terminal.

36. The method as recited in claim 34, wherein the data broadcasting contents are directly downloaded through a return channel server.

37. A data broadcasting application structure for providing a personalized data broadcasting service, comprising:
one application start file;
first resource files which are suitable for first user information; and
second resource files which are suitable for second user information,
wherein the application start file is commonly used in the first resource files and the second resource files.

38. A system for providing a personalized data broadcasting service, comprising:
an archiver storing contents;
an encoding means for encoding the contents; and
a multiplexing/modulating means for multiplexing, modulating the output signal of the encoding means and transmitting the output signal to a user terminal through a broadcasting network,
wherein the contents include:
a data broadcasting application; and
contents metadata for the data broadcasting application,
wherein the data broadcasting application includes:
first resource files which are suitable for first user information;
second resource files which are suitable for second user information; and
one application start file commonly used for the first resource files and the second resource files.

39. The system as recited in claim 38, wherein the metadata include:
metadata having information on a schedule of a data broadcasting service;
metadata having information on content and description of the data broadcasting service; and
metadata having location information of the data broadcasting application.

40. A user terminal, comprising:
a personalized broadcasting middleware for selecting data broadcasting contents suitable for user information by using contents metadata having information on a data broadcasting service and user information metadata having user information; and
a data broadcasting middleware for executing the selected data broadcasting contents based on signaling information,
wherein the selected data broadcasting contents are received through a broadcasting network.

41. The terminal as recited in claim 40, wherein the personalized broadcasting middleware searches location information of the selected data broadcasting contents based on a TVA location resolution mechanism.

42. The terminal as recited in claim 41, wherein when the contents for the data broadcasting service have been stored in a contents storage of the user terminal based on schedule information through the broadcasting network, the personalized broadcasting middleware shifts data broadcasting contents having the searched location information among the stored contents, to an execution location.

43. The terminal as recited in claim 41, wherein the personalized broadcasting middleware provides the searched location information to the data broadcasting middleware, and the data broadcasting middleware extracts data broadcasting contents having the searched location information among data broadcasting contents inputted according to schedule information through the broadcasting network, and stores the extracted data broadcasting contents in an execution location.

44. A method for providing a personalized data broadcasting service, comprising the steps of:
a) storing contents;
b) coding the contents; and
c) multiplexing, modulating an output signal of the step b) and transmitting the multiplexed and modulated signal to a user terminal through a broadcasting network,
wherein the contents include:
a data broadcasting application; and
contents metadata which are metadata with respect to the data broadcasting application,
wherein the data broadcasting application includes:
the first resource files which are suitable for the first user information;
the second resource files which are suitable for the second user information; and
one application start file which are commonly used in the first resource files and the second resource files.

45. The method as recited in claim 44, wherein the metadata include:
metadata having information on a schedule of a data broadcasting service;
metadata having information on content and detailed description of the data broadcasting service; and
metadata having location information of the data broadcasting application.

46. A method for using a personalized data broadcasting service, comprising the steps of:
a) selecting data broadcasting contents suitable for user information by using contents metadata having information on a data broadcasting service and user information metadata having user information; and
b) executing the selected data broadcasting contents based on signaling information,
wherein the selected data broadcasting contents are transmitted through a broadcasting network.

47. The method as recited in claim 46, wherein location information of the selected data broadcasting contents is searched based on a TVA location resolution mechanism.

48. The method as recited in claim 47, further comprising the step of:
c) shifting data broadcasting contents which have the searched location information among the stored contents to an execution location in the personalized broadcasting middleware, when the contents for the data broadcasting service have been stored in a contents storage of the user terminal based on schedule information through the broadcasting network.

49. The method as recited in claim 47, further comprising the step of:
d) extracting data broadcasting contents having the searched location information from data broadcasting contents inputted according to schedule information through the broadcasting network, and storing the extracted data broadcasting contents in an execution location.
